(19) United States
(12) Patent Application Publication
(10) Pub. No.: US 2006/0228679 A1
(43) Pub. Date: Oct. 12, 2006

(54) Communcation device

(76) Inventor: Kathleen T. Romano, Holbrook, NY (US)

Correspondence Address: LILLIE LAW, LLC, 269 SOUTHPORT ST, RONKONKOMA, NY, 11779, US

(21) Appl. No.: 11/103,830

(22) Filed: Apr. 12, 2005

(51) Int. Cl. G09B 19/00

(52) U.S. Cl. 434/167

(57) ABSTRACT

A communication device comprising a glove having a plurality of sides, each having at least an upper, and a lower portion; wherein the upper portion includes a plurality of digits; wherein at least lower portion has means for communication.

### BACKGROUND OF THE INVENTION

This invention relates to a communication device, particularly, at least one glove having means for communicating.

Historically, gloves and/or mittens (hereafter glove(s)) have been used for a plethora of common uses including, inter alia, protecting one's hands from exposure to excessive temperatures and duration thereof, chemicals, electricity, abrasions, sunlight, soil, etc. Moreover, less common functions and features of gloves have additionally been extended to include educational, amusement, and/or communication purposes (U.S. Pat. Nos. 1,624,429, 1,630,730, 4,519,781, 6,142,785, and Des. 335,024). However, there is an absence in the prior publications of providing a novel device having means for communication as set forth hereinbelow.

### SUMMARY OF THE INVENTION

In light thereof, an object of this invention is to provide at least one glove having means for communicating.

It is an object of the present disclosure to provide a novel communication device which is entertaining to use.

It is another object of the present disclosure to provide a novel communication device which is educational.

It is still another object of the present disclosure to provide a communication device comprising a glove having a plurality of sides, each having at least an upper, and a lower portion; wherein the upper portion includes a plurality of digits; wherein at least one lower portion has means for communication.

It is additional object of the present disclosure to provide a communication device wherein said means includes at least one letter forming a word.

It is a further additional object of the present disclosure to provide a communication device wherein said means includes a plurality of letters forming a word.

It is a further object of the present disclosure to provide a communication device wherein said means includes at least one number.

A further object of the present disclosure is to provide a communication device wherein said means includes a plurality of numbers.

It is an additional object of the present disclosure to provide a communication device wherein said means includes a member selected from the consisting of: an acronym, an icon, a letter, and a number.

It is an object of the present disclosure to provide a communication device wherein said device includes a plurality of gloves.

It is an object of the present disclosure to provide a communication device comprising at least one pair of gloves, each glove having a plurality of sides and a lower portion, and, optionally, an upper portion; wherein said upper portion includes a plurality of digits, wherein at least one lower portion has means for communication.

It is an object of the present disclosure to provide a communication device wherein said pair is used in combination.

It is an object of the present disclosure to provide a communication device wherein said combination forms a member selected from a group consisting of: a phrase, and a sentence.

Accordingly, it would be beneficial therefore to provide a novel communication device which is of relatively noncomplex construction, inexpensive to manufacture, and easy to use. Other objectives, advantages, and novel features of the present invention will become more apparent from the following detailed description when taken in conjunction with the accompanying drawings.

### BRIEF DESCRIPTION OF THE DRAWINGS

The following drawings, in which like reference characters indicate like parts, are provided for illustration of the invention and are not intended to limit the invention in any manner whatsoever.

FIG. 1 is a front view of a first combination of a preferred embodiment of the present invention, namely the palm side of a first and second glove;

FIG. 2 is a front view of a second combination of a preferred embodiment of the present invention, namely, the dorsal side of a first and second glove;

FIG. 3 is a front view of a third combination of a preferred embodiment of the present invention, namely, the palm side of a first glove, and the dorsal side of a second glove; and

FIG. 4 is a front view of a fourth combination of a preferred embodiment of the present invention, namely, the dorsal side of a first glove and the palm side of a second glove.

### DETAILED DESCRIPTION OF THE INVENTION

The following descriptions of the preferred embodiments are presented to illustrate the present invention and are not to be construed to limit the claims in any manner whatsoever.

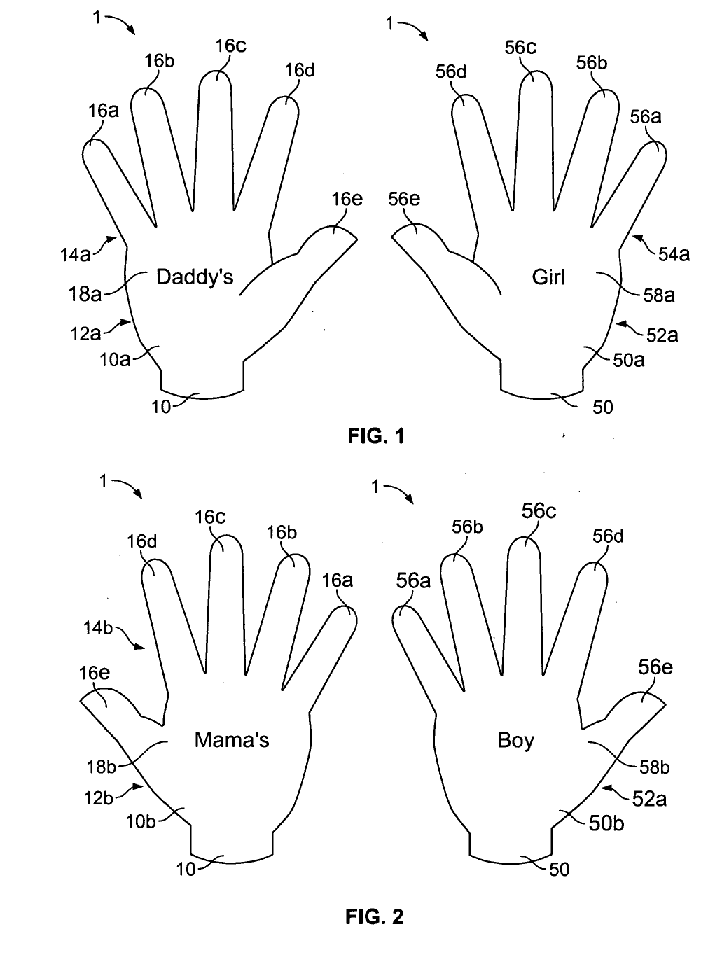

Referring generally to drawings FIGS. 1 to 4, wherein like reference numerals identify similar structural elements of the device set forth herein. FIG. 1 illustrates a communication device 1 comprising: at least one pair of gloves, namely, a first glove 10 and second glove 50. Each glove 10, 50 having a plurality of sides 10a, 10b and 50a, 50b respectively; and a lower portion 12a, 12b and 52a, 52b, and, optionally, an upper portion 14a, 14b and 54a, 54b; wherein said upper portion 14a, 14b and 54a, 54b includes a plurality of digits 16a to 16e and 56a to 56e. Moreover, it is envisioned that said upper portion 14a, 14b and 54a, 54b may be limited to include egress for a plurality of digits (i) without covering the digits (ii) only partially covering the digits a combination thereof (not shown); for example, weight lifting gloves typically have a shortened upper portion and do not cover the tips of the digits. Nonetheless, each glove has at least one lower portion 12a, 12b and 52a, 52b having means for communication 18a, 18b and 58a, 58b. More specifically, FIG. 1 illustrates a front view of a first combination of a preferred embodiment of the present invention, namely the palm side 10a, 50a of a first and second glove 10, 50 displaying the combination expression “Daddy's Girl.”

Wherein FIG. 2 illustrates a front view of a second combination of a preferred embodiment of the present invention, namely, the dorsal side 10b, 50b of a first and second glove 10, 50 displaying the combination expression “Mama's Boy.”

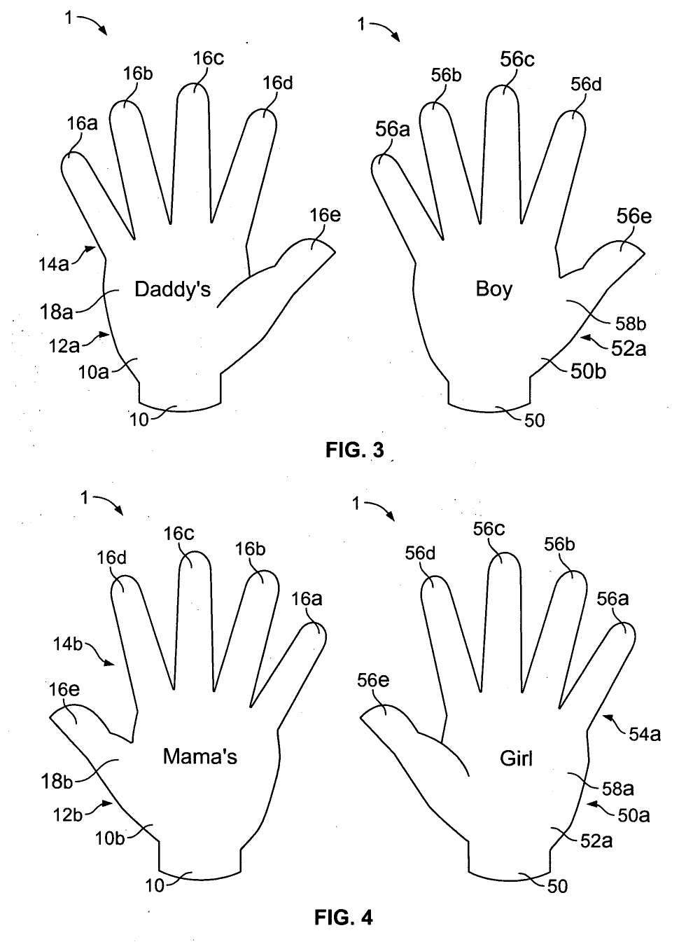

Moreover, FIG. 3 illustrates a front view of a third combination of a preferred embodiment of the present invention, namely, the palm side 10a of a first glove 10, and the dorsal side 50b of a second glove 50 displaying the combination expression “Daddy's Boy.”

Lastly, FIG. 4 illustrates a front view of a fourth combination of a preferred embodiment of the present invention, namely, the dorsal side 10b of a first glove 10 and the palm side 50a of a second glove 50 displaying the combination expression “Mama's Boy.”

The communication device 1 has means for communication that may be an acronym, an icon, a letter, a number, a symbol and/or any combination or plurality thereof including punctuation marks. For example, the communication device 1 may be used as a one-glove expression or statement, a two-glove expression or statement, a one sided and/or two sided per glove. In alternative embodiments, words and expressions may be split between the two gloves and sides. Furthermore, it is envisioned that expressions may include, inter alia, spoiled brat, daddy's girl, bad girl, naughty girl, good girl, angel baby, angel face, Italian princess, little princess, and sweetie pie.

Moreover, all of the above referenced patents; patent applications and publications are hereby incorporated by reference. Many variations of the present invention will suggest themselves to those of ordinary skill in the art in light of the above detailed description. Furthermore, the described embodiments of the present invention are intended to be illustrative rather than restrictive, and are not intended to represent every embodiment of the present invention. All such obvious modifications are within the full-intended spirit and scope of the claims of the present application, wherein such modifications and variations can be made without departing from the spirit or scope of the invention as set forth in the claims herein below both literally and in equivalents recognized in law.

What is claimed is:

1. A communication device comprising:
a glove having a plurality of sides, each having at least an upper, and a lower portion; wherein the upper portion includes a plurality of digits; wherein at least one lower portion has means for communication.

2. A communication device as in claim 1, wherein said means includes at least one letter forming a word.

3. A communication device as in claim 1, wherein said means includes a plurality of letters forming a word.

4. A communication device as in claim 1, wherein said means includes at least one number.

5. A communication device as in claim 1, wherein said means includes a plurality of numbers.

6. A communication device as in claim 1, wherein said means includes a member selected from the consisting of: an acronym, an icon, a letter, and a number.

7. A communication device as in claim 1, wherein said device includes a plurality of gloves.

8. A communication device comprising:
at least one pair of gloves, each glove having a plurality of sides and a lower portion, and, optionally, an upper portion; wherein said upper portion includes a plurality of digits, wherein at least one lower portion has means for communication.

9. A communication device as in claim 8, wherein said pair is used in combination.

10. A communication device as in claim 8, wherein said means includes at least one letter forming a word.

11. A communication device as in claim 8, wherein said means includes a plurality of letters forming a word.

12. A communication device as in claim 8, wherein said means includes at least one number.

13. A communication device as in claim 8, wherein said means includes a plurality of numbers.

14. A communication device as in claim 8, wherein said means includes a member selected from the group consisting of: an acronym, an icon, a letter, and a number.

15. A communication device as in claim 9, wherein said combination forms a member selected from a group consisting of: a phrase, and a sentence.
